(19) United States
(12) Patent Application Publication
(10) Pub. No.: US 2005/0026590 A1
(43) Pub. Date: Feb. 3, 2005

(54) Low-cost S-UMTS based distress transmitters for personal use

(76) Inventor: Wouter De Win, Zaventem (BE)

Correspondence Address: PERMAN & GREEN, 425 POST ROAD, FAIRFIELD, CT, 06824, US

(21) Appl. No.: 10/845,731

(22) Filed: May 14, 2004

(30) Foreign Application Priority Data
Aug. 1, 2003 (GB) 0318029.6

(51) Int. Cl. H04M 11/04

(52) U.S. Cl. 455/404.1; 455/404.2

(57) ABSTRACT

A communication device for S-UMTS based distress signal transmission includes a first communication means arranged for mobile communication according to a first protocol, and an S-UMTS communication means arranged for sending an S-UMTS distress signal. The first communication means and the S-UMTS communication means share hardware components which are arranged to be reconfigured for mobile communication according to the first protocol or for sending an S-UMTS distress signal.

### FIELD OF THE INVENTION

The present invention is related to spread-spectrum transceiving technology, more particularly to the use of UMTS (Universal Mobile Telecommunication System) in a search and rescue (SAR) system.

### BACKGROUND OF THE INVENTION AND STATE OF THE ART

Search and rescue systems based on distress beacons allow a user to send a distress alert when he finds himself in a life-threatening situation. Today's SAR systems are usually dependent upon a terrestrial wireless network, or are unaffordable for most people. An emergency paging system should however be accessible to the majority of people, so that everybody can benefit from the system. A further requirement is worldwide coverage support.

At the moment, some niche market products for professional use exist. These are expensive systems, which are stand-alone applications that are not at all integrated with personal communication networks and are therefore not suited for a low-cost mass-market approach. Standard satellite telephones can be used for emergency paging and some systems guarantee a worldwide coverage. However, satellite telephone systems are very expensive, especially when the added value is restricted to the SAR system. Also, some systems are based on second and third generation terrestrial networks. Helpful applications such as collision report for e.g. cars are easy to implement but these applications are restricted to the network's coverage, making SAR for remote locations impossible. Moreover, terrestrial networks are vulnerable to natural and man-made disasters, thereby failing when search and rescue operations are very much demanded.

There is thus a need for a worldwide satellite based search and rescue system using small, low-cost and easy to integrate distress beacons.

### AIMS OF THE INVENTION

The present invention aims to provide a low-cost distress alert system with a worldwide coverage.

### SUMMARY OF THE INVENTION

The present invention concerns a communication device for S-UMTS based distress signal transmission, comprising:
A first communication means arranged for mobile communication according to a first protocol, and
An S-UMTS communication means arranged for sending an S-UMTS distress signal,
   characterised in that said first communication means and said S-UMTS communication means share hardware components which are arranged to be reconfigured for mobile communication according to said first protocol or for sending an S-UMTS distress signal.

In a first embodiment, the communication device of the invention is characterised in that the first protocol is T-UMTS, the first communication means and the S-UMTS communication means at least partially sharing an extended RF module arranged for use with both T-UMTS and S-UMTS, a reconfigurable baseband component and a reconfigurable dual protocol stack, both arranged for T-UMTS signal transceiving and S-UMTS distress signal transmission.

In an alternative embodiment, the first communication protocol is GPS, and a switch is provided to select operation mode to receiving GPS signals or transmitting an S-UMTS signal.

Another aspect of the present invention concerns a communication device for S-UMTS based distress signal transmission, comprising:
A baseband module designed for generating the necessary baseband waveform for transmitting an S-UMTS based distress signal, and
An RF-module arranged for converting the baseband waveform generated by said baseband module to the appropriate frequency band used for S-UMTS based distress signal transmission.

Such a communication device can be further characterised in that it further comprises a first communication means being a GPS module, wherein a switch is provided to select operation mode to receiving GPS signals or transmitting an S-UMTS distress signal.

Alternatively, the communication device can further comprise a first operational means being a battery operated handheld computer.

The communication device may, according to the present invention, be integrated into a motorised vehicle. The on-board electronics and/or computer may be used in order to provide an S-UMTS communication means arranged for sending an S-UMTS distress signal.

In another embodiment of the present invention, the RF-module of the communication device comprises a high power amplifier (HPA) that operates at low input back off (IBO). Although this will decrease the efficiency of the distress transmitter and introduce more distortion to the transmitted waveform, these side effects are not critical for the provision of the distress alert service.

Alternatively, the communication device of the present invention, when configured for the S-UMTS communication means, may reuse existing high power amplifier at a lower input back off wherein the average output power is increased.

The communication device of the present invention may be further characterised in that the S-UMTS communication means are arranged to transmit a recorded voice message containing positioning information along with the distress alert message.

### SHORT DESCRIPTION OF THE DRAWINGS

FIG. 1 represents S-UMTS (satellite UMTS) based distress alert transmitter functionality integrated in a conventional T-UMTS (terrestrial UMTS) terminal.

FIG. 2 represents an S-UMTS based distress alert transmitter module integrated in a GPS (Global Positioning System) receiver.

### DETAILED DESCRIPTION OF THE INVENTION

The invention concerns a low-cost distress alert system with worldwide coverage. For a distress alert system to be successful, it should be implemented as an easily accessible extra tool on a device that has a different main purpose. Examples of such devices are T-UMTS terminals and GPS receivers. Other considerations to make is that a distress alert transmission does not need real-time communication, and that hardware implementations of such a functionality should be cheap and easily integrated into other spread-spectrum devices.

### EXAMPLE 1

T-UMTS Terminal with Integrated S-UMTS Based Distress Alert Transmitting Functionality:

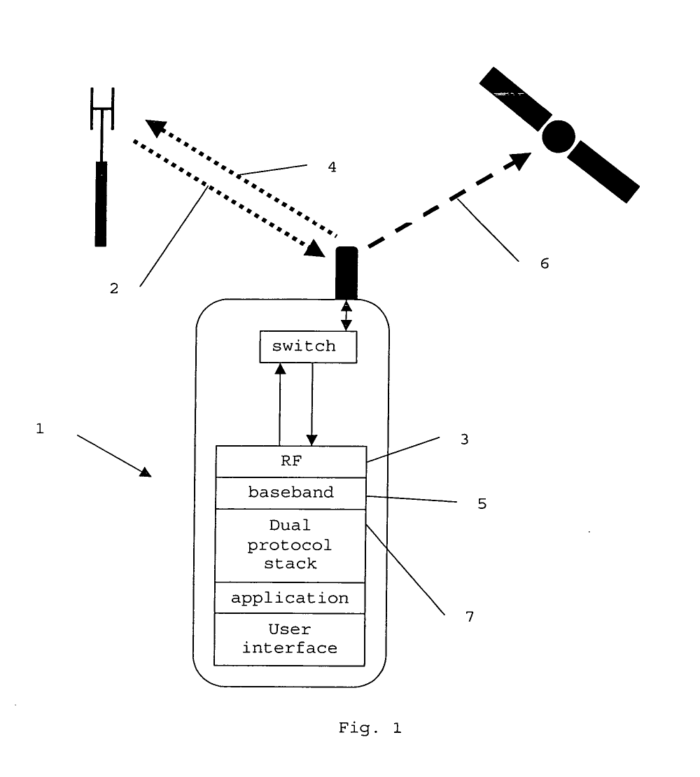

FIG. 1 gives an overview of this terminal architecture 1.

This terminal is able to work in two modes. In the first mode, it works as a classical T-UMTS terminal. This means that both uplink 2 and downlink 4 are needed for normal use. In the second mode, the hardware and software is reconfigured so that it represents an S-UMTS based distress alert transmitter. Basically, this can be seen as a specific terminal class for the satellite component of UMTS. For this distress alert transmitter functionality, only satellite uplink (6) capability is needed.

Because there exists a high convergence between the T-UMTS and the S-UMTS systems, a lot of the hardware can be reused for both modes. In the RF part (3), only an extra local oscillator and some additional filters are necessary. Baseband part (5) and protocol stack (7) are implemented as reconfigurable blocks and can thus be reconfigured without the need for additional hardware.

Hardware reuse can further be improved by specifying the distress terminal class in such a way that it is adapted to the specific nature of the service. This includes the following characteristics:
Transmission delay can be in the order of seconds. No real time communication is necessary.
A very low bit rate is sufficient (in the order of 10 to 100 bps). This enables the use of very high processing and coding gains and hence improves the usability inside buildings, parking lots, dense woods, hilly area, etc.
Low power consumption and efficiency are of secondary importance during a distress alert transmission. Therefore, RF-components can operate at maximum power output instead of maximum signal quality. Another possibility is to use some RF-components outside their optimum frequency band.
During the transmission of an S-UMTS distress alert message, the HPA (high power amplifier) in the RF-module can be reconfigured to work at a smaller IBO (input back off) in order to boost the output power thereby increasing the probability that the signal will be detected by the S-UMTS network.
Distress alert messages are very short and can be transmitted as a burst. Burst repetition is an easy way to improve communications reliability.
If localisation data cannot be based on GPS measurements, voice or text based localisation data can be used instead. Such data can be recorded in a non real-time fashion. In this way, a GPS receiver can be omitted. Memory for data recording is cheap and small.
Interference generated to other users in the satellite and terrestrial band should not be a major issue when people are in danger. Distress alert messages should have the highest priority in the network. Therefore, terminals can transmit at maximum power, independent of actual channel conditions. As a result, power control can be omitted and no return channel is necessary.

In this example the distress alert transmitting functionality is completely integrated with the existing hardware of a T-UMTS terminal. The terminal will operate either as a standard T-UMTS phone or as a special class S-UMTS terminal. This is possible because the S-UMTS waveform is almost identical to the T-UMTS variant. Moreover, only a small part of the S-UMTS protocol stack needs to be implemented.

### EXAMPLE 2

S-UMTS Based Distress Alert Transmitter Module for Integration in GPS Receivers:

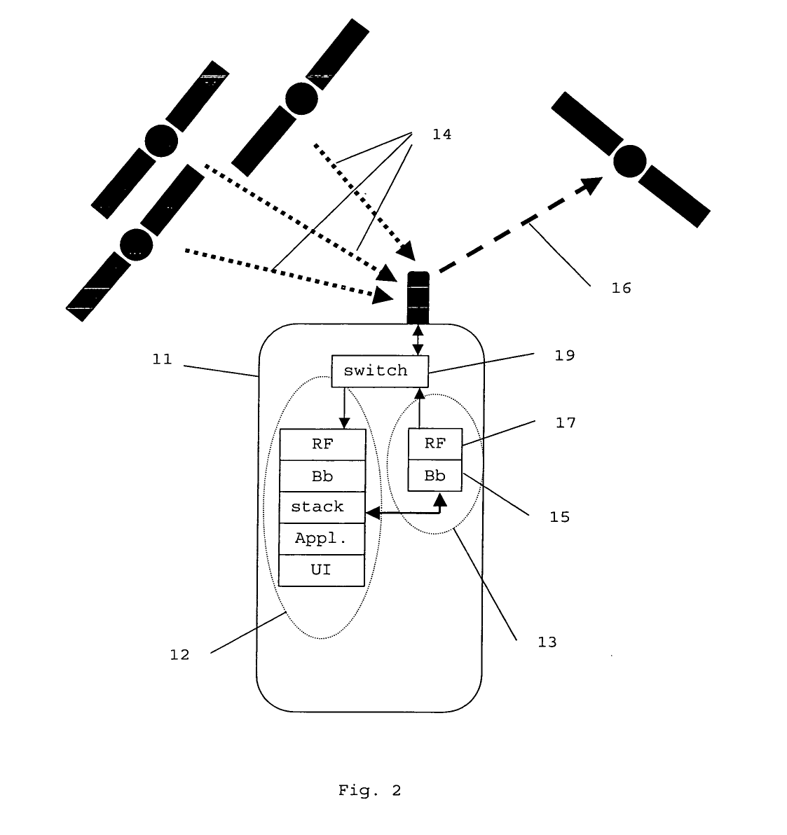

A second architecture approach is the incorporation of an S-UMTS based distress alert transmitter module 13 in a GPS receiver 11, as can be seen in FIG. 2. The provision of a distress alert capability is highly relevant for a GPS receiver because they are often used on remote locations. Next to the traditional GPS hardware 12, extra hardware can be limited to the necessary baseband (15) and RF (17) hardware for transmission of the S-UMTS waveform plus a supplementary duplexer or switch (19). Specific user interface, application and protocol stack functions can be handled by a small adaptation of the software. FIG. 2 gives an overview of this architecture. GPS signals 14 are received from different satellites under normal use. When using the provided SAR facilities, a distress alert 16 can be sent via S-UMTS.

### EXAMPLE 3

S-UMTS Based Distress Alert Transmitter Module for Integration in a Personal Digital Assistant (PDA):

Many people today use already a Personal Digital Assistant (PDA) or a battery operated handheld computer to organise their professional and personal live. Because these devices are designed with the goal to be carried closely by the users they are perfectly suited to host a distress alert transmitter. In this way the device becomes a “Personal Safety Assistant” capable of sending a distress alert over the S-UMTS network whenever this might be necessary. While this functionality can be useful for everybody on the move, it can especially enhance the safety of elderly, diseased and disabled people. Integration can be done in a low-cost fashion by including a baseband and RF module plus antenna for transmission of the S-UMTS waveform in a similar way as for the GPS device explained in example 2. For the user interface, application and protocol stack functions, the existing PDA hardware can be reused without any significant alterations.

### EXAMPLE 4

S-UMTS Based Distress Alert Transmitter Module for Integration in Private and Public Motorised Vehicles:

Many cars and trucks, as well as public transport vehicles are hosting one or multiple on-board computers and electronics. Motorised vehicles can get people easily outside terrestrial coverage and even within remote locations. Collisions and accidents happen frequently and often have serious consequences. In most cases it is critical that medical services can be alerted as fast as possible. In this context, the integration of an S-UMTS based distress alert transmitter module inside motorised vehicles can improve reaction time in case of an accident. If integration is performed with existing on-board electronics, again, extra hardware can be limited to the necessary baseband (15) and RF (17) hardware for transmission of the S-UMTS waveform plus an outside mounted antenna.

1. A communication device for S-UMTS based distress signal transmission, comprising:
A first communication means arranged for mobile communication according to a first protocol, and
An S-UMTS communication means arranged for sending an S-UMTS distress signal,
wherein the first communication means and the S-UMTS communication means share hardware components which are arranged to be reconfigured for mobile communication according to the first protocol or for sending an S-UMTS distress signal.

2. Communication device as in claim 1, wherein the first protocol is T-UMTS, the first communication means and the S-UMTS communication means at least partially sharing an extended RF module arranged for use with both T-UMTS and S-UMTS, a reconfigurable baseband component and a reconfigurable dual protocol stack, both arranged for T-UMTS signal transceiving and S-UMTS distress signal transmission.

3. A communication-device for S-UMTS based distress signal transmission, comprising:
A baseband module designed for generating the necessary baseband waveform for transmitting an S-UMTS based distress signal, and
An RF-module arranged for converting the baseband waveform generated by said baseband module to the appropriate frequency band used for S-UMTS based distress signal transmission.

4. Communication device as in claim 3, further comprising a first communication means being a GPS module, wherein a switch is provided to select operation mode to receiving GPS signals or transmitting an S-UMTS distress signal.

5. Communication device as in claim 3, further comprising a first operational means being a battery operated handheld computer.

6. Communication device as in claim 3 integrated into a motorised vehicle.

7. Communication device as in claim 6, wherein the on-board electronics and/or computer are used in order to provide an S-UMTS communication means arranged for sending an S-UMTS distress signal.

8. Communication device as in claim 3 wherein the RF-module comprises a high power amplifier that operates at low input back off.

9. Communication device as in claim 1 that, when configured for the S-UMTS communication means, reuses existing high power amplifier at a lower input back off wherein the average output power is increased.

10. Communication device as in claim 1, wherein the S-UMTS communication means are arranged to transmit a recorded voice message containing positioning information along with the distress alert message.

11. A communication device for S-UMTS based distress signal transmission, comprising:
a baseband module designed for generating the necessary baseband waveform for transmitting an S-UMTS based distress signal,
an RF-module arranged for converting the baseband waveform generated by the baseband module to the appropriate frequency band used for S-UMTS based distress signal transmission, and
a first communication means being a GPS module, wherein a switch is provided to select operation mode to receiving GPS signals or transmitting an S-UMTS distress signal.
